(19) United States
(12) Patent Application Publication
(10) Pub. No.: US 2008/0155611 A1
(43) Pub. Date: Jun. 26, 2008

(54) TELEVISION LAN SIGNAL-SEPARATING APPARATUS, INDOOR LAN SYSTEM AND TELEVISION LAN SIGNAL-SEPARATING METHOD

(75) Inventor: Tooru NAKAGAWA, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/834,301

(22) Filed: Aug. 6, 2007

(30) Foreign Application Priority Data
Dec. 22, 2006 (JP) 2006-346478

(51) Int. Cl. H04N 7/18

(52) U.S. Cl. 725/85

(57) ABSTRACT

The invention provides an indoor LAN system, including: a distributor for distributing or delivering a television signal having a frequency band contained in a first frequency band, and a LAN signal having a frequency band contained in a second frequency band to a plurality of common antenna terminals provided in a plurality of rooms through house wirings, respectively; a television•LAN signal-separating apparatus for receiving as its inputs the television signal and the LAN signal through corresponding one of the plurality of common antenna terminals provided in the plurality of rooms, respectively, and outputting the television signal and the LAN signal to a television signal-outputting portion and a LAN signal-outputting portion, respectively, through signal separation; and a display device for processing at least one of the television signal and the LAN signal separated from each other in the television•LAN signal-separating apparatus.

The present application is based on Japanese patent application No. 2006-346478, the entire contents of which are incorporated herein by reference.

### BACKGROUND

1. Field

One embodiment of the invention relates to a television•LAN signal-separating apparatus, an indoor LAN system, and a television•LAN signal-separating method, and more particularly to an indoor LAN system using house wirings used for reception of television broadcasting waves.

2. Description of the Related Art

An indoor Internet system utilizing coaxial lines which are used for reception of television broadcasting waves and which are wired in rooms in a house, respectively, and television receivers is known as a conventional technique. This conventional technique, for example, is disclosed in the Japanese Patent Kokai No. 2000-13382.

According to this indoor Internet system, a Web terminal can be connected to the Internet through a Web server connected to the Internet via a public line or a network line for the Internet by merely being connected to corresponding one of coaxial lines which are used for reception of television broadcasting waves and which are wired in rooms in a house, respectively. In this indoor Internet system, a two-way distributor superimposes a television signal and a LAN signal outputted from the Web terminal on each other, and the resulting superimposed signal is distributed to the rooms so that it can be utilized in each of the rooms.

However, in the conventional indoor Internet system, since the LAN signal has a narrow band of about 10 MHz, there is a limit to high-speed promotion for a signal transmission speed. In addition, a dedicated connector is required to input the superimposed signal distributed to the rooms to each of the Web terminal and the television receiver. This is a troublesome problem.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a home network as an indoor LAN system according to an embodiment of the invention;

FIG. 2 is an exemplary block diagram of a distributor with a hub function according to the embodiment of the invention;

FIG. 3 is an exemplary block diagram of a signal separating apparatus according to the embodiment of the invention;

FIG. 4 is an exemplary schematic diagram showing flows of signals in the home network according to the embodiment of the invention; and

FIG. 5 is an exemplary schematic diagram showing a frequency band in the embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a television•LAN signal-separating apparatus, including: an inputting portion for receiving as its inputs a television signal having a frequency band contained in a first frequency band, and a local area network (LAN) signal having a frequency band contained in a second frequency band through corresponding one of a plurality of common antenna terminals provided in a plurality of rooms, respectively; a signal separating portion for separating the television signal and the LAN signal from each other in accordance with the first and second frequency bands; a first outputting portion for outputting the television signal to a television receiver; and a second outputting portion for outputting the LAN signal to an electronic apparatus.

According to the constitution as described above, the television signal and the LAN signal can be separated from each other, and can be outputted to the television receiver and the electronic apparatus, respectively.

In addition, according to a further embodiment of the invention, there is provided an indoor LAN system, including: a distributor for distributing or delivering a television signal having a frequency band contained in a first frequency band, and a LAN signal having a frequency band contained in a second frequency band to a plurality of common antenna terminals provided in a plurality of rooms through house wirings, respectively; a television•LAN signal-separating apparatus for receiving as its inputs the television signal and the LAN signal through corresponding one of the plurality of common antenna terminals provided in the plurality of rooms, respectively, and outputting the television signal and the LAN signal to a television signal-outputting portion and a LAN signal-outputting portion, respectively, through signal separations; and a display device for processing at least one of the television signal and the LAN signal separated from each other in the television•LAN signal-separating apparatus.

According to the constitution as described above, it is possible to construct the indoor LAN system using the house wirings.

Moreover, according to a still further embodiment of the invention, there is provided a television•LAN signal-separating method, including the steps of: receiving as inputs a television signal having a frequency band contained in a first frequency band, and a LAN signal having a frequency band contained in a second frequency band through corresponding one of a plurality of common antenna terminals provided in a plurality of rooms, respectively; separating the television signal and the LAN signal from each other in accordance with the first and second frequency bands; outputting the television signal to a television receiver; and outputting the LAN signal to an electronic apparatus.

According to the television•LAN signal-separating method as described above, the television signal and the LAN signal can be separated from each other and can be outputted to the television receiver and the electronic apparatus, respectively.

According to the invention, it is possible to separate the television signal and the LAN signal which are propagated through the corresponding one of the house wirings from each other, and it is possible to construct the indoor LAN system utilizing the house wirings.

A television•LAN signal-separating apparatus, an indoor LAN system, and a television•LAN signal-separating method according to an embodiment of the invention will be described in detail hereinafter with reference to the accompanying drawings.

[Constitution of Home Network]

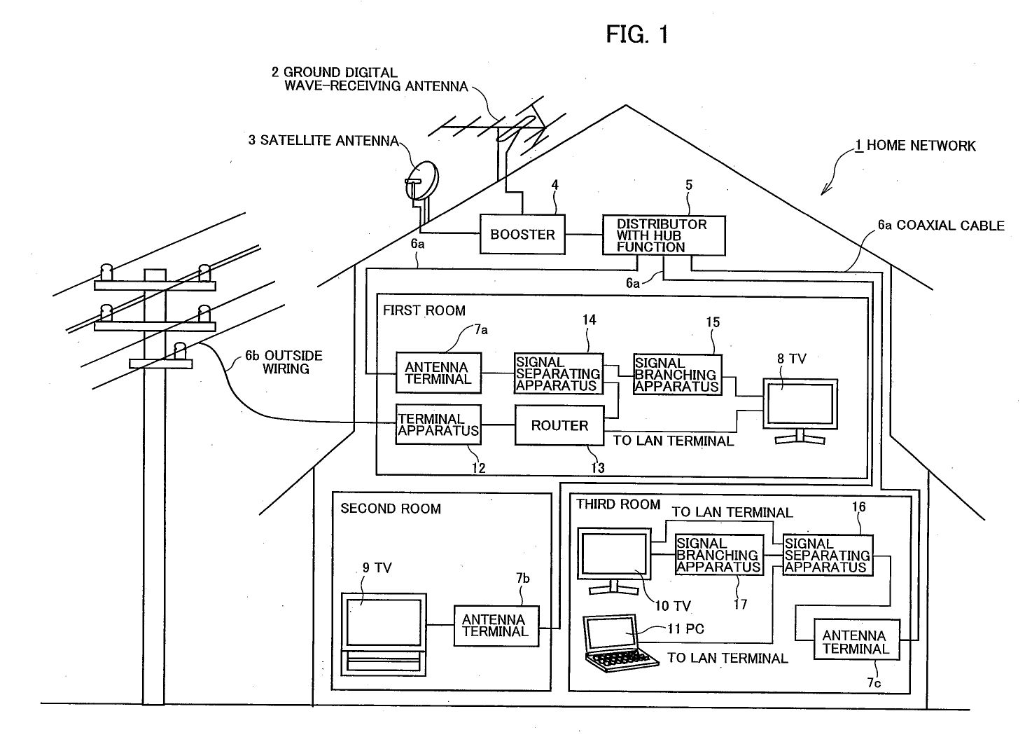

FIG. 1 is an exemplary schematic diagram of a home network as an indoor LAN system according to an embodiment of the invention.

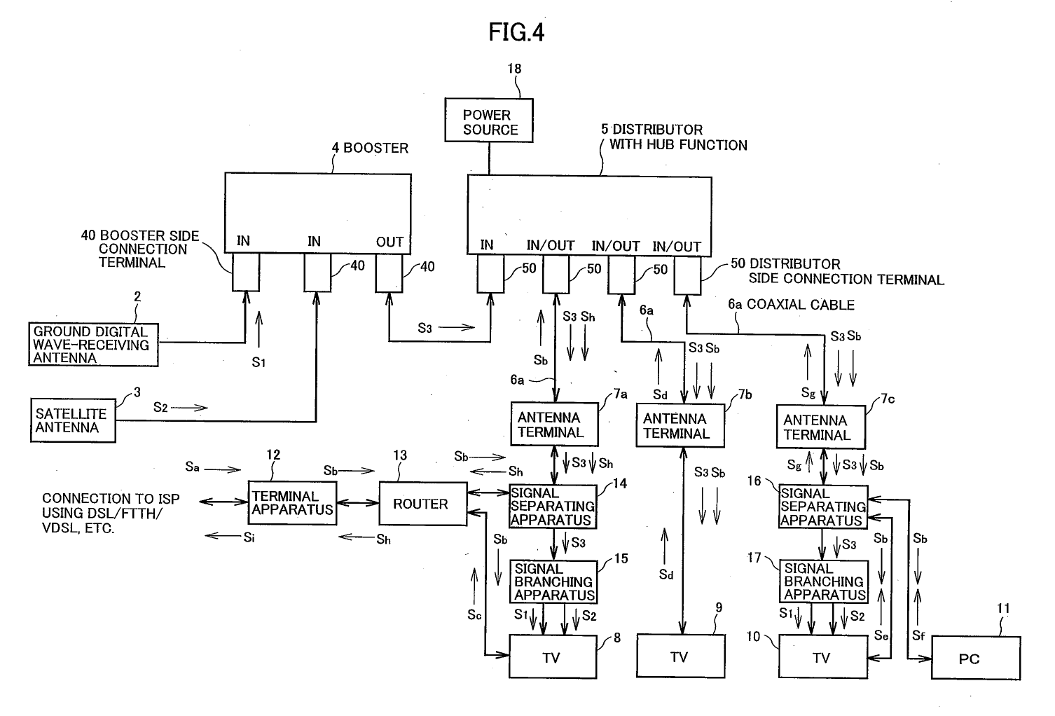

The home network 1 includes a ground digital wave-receiving antenna 2 which receives thereat a ground digital television signal, a satellite antenna 3 which receives thereat a satellite television signal, a booster 4 which amplifies the ground digital television signal and the satellite television signal which are received at the ground digital wave-receiving antenna 2 and the satellite antenna 3, respectively, a distributor 5 with a hub function which distributes each of the television signals amplified by the booster 4 to first to third rooms, coaxial cables 6a as house wirings which are wired in the first to third rooms, respectively, through the distributor 5 with a hub function and through which the television signals or the like are propagated, an outside wiring 6b which is wired in a house from a public line, antenna terminals 7a to 7c which are installed in the first to third rooms, respectively, and which are connected to the coaxial cables 6a, respectively, a television 8 which has a LAN terminal and which can be connected to the Internet, a television 9 which has a LAN terminal and which has a function of separating the television signal and the LAN signal from each other, a television 10 which has a LAN terminal and which can be connected to the Internet, a personal computer (PC) 11 which has a LAN terminal and which can be connected to the Internet, a terminal apparatus 12 which converts an analog signal or a digital signal transmitted through the outside wiring 6b into a LAN signal, and converting a LAN signal from the PC 11 or the like into an analog signal or a digital signal, a router 13 which distributes the LAN signal from the terminal apparatus 12 to the television 8 and a signal separating apparatus 14 (refer to FIG. 4), the separating apparatuses 14 and 16 which separate the television signals and the LAN signals inputted thereto through the antenna terminals 7a and 7c, respectively, from each other, and signal branching apparatuses 15 and 17, each serving as a first outputting portion, which branches the ground digital television signals and the satellite television signals from each other.

[Constitution of Distributor with Hub Function]

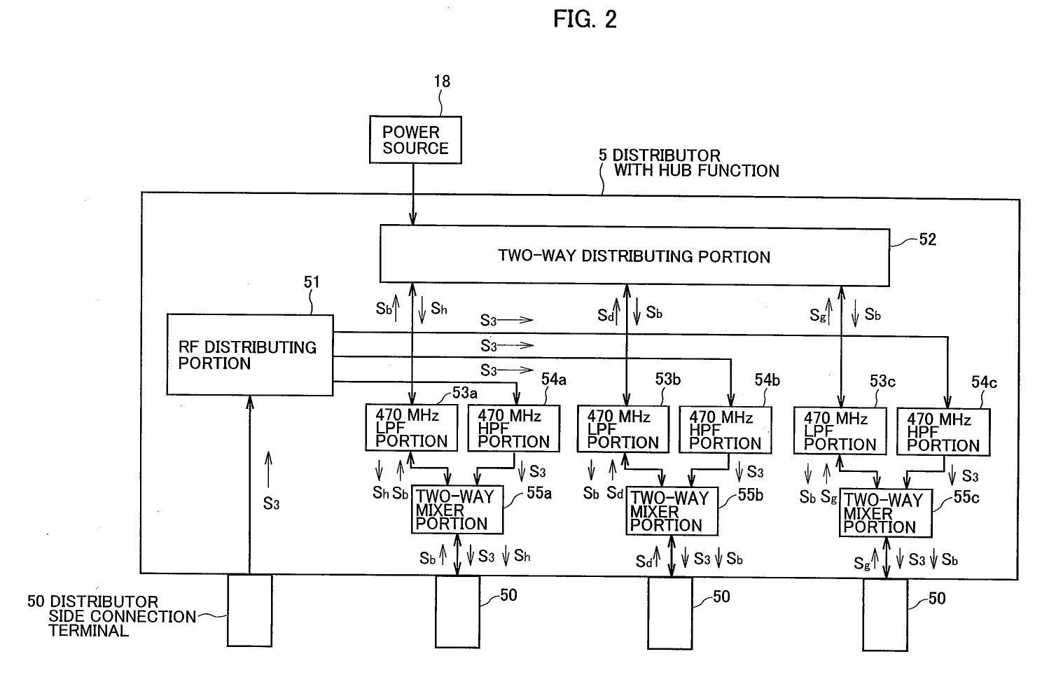

FIG. 2 is an exemplary block diagram of the distributor with a hub function according to the embodiment of the invention. In the figure, reference symbols S_{b}, S_{d}, S_{g} and Sₕ designate the LAN signals, respectively, and reference symbol S₃ designates the television signal obtained by multiplexing the ground digital television signal and the satellite television signal.

The distributor 5 with a hub function includes a power source 18 which supplies an electric power to each of the portions, a plurality of distributor side connection terminals 50 which are connected to the coaxial cables 6a, respectively, a radio frequency (RF) distributing portion 51 which distributes and outputs the television signal S₃ to 470 MHz high pass filter (HPF) portions 54a to 54c, a two-way distributing portion 52 which distributes and outputs the LAN signals S_{b}, S_{d} and S_{g} thus inputted thereto in the form of the LAN signals Sₕ, S_{b} and S_{b} to 470 MHz low pass filter (LPF) portions 53a to 53c, respectively, the 470 MHz LPF portions 53a, 53b and 53c which pass therethrough signal components having frequency bands each being lower than 470 MHz of the LAN signals Sₕ and S_{b}, the LAN signals S_{b} and S_{d}, and the LAN signals S_{b} and S_{g} inputted thereto, the 470 MHz HPF portions 54a to 54c which pass therethrough signal components having frequency bands each being 470 MHz or more of the television signals S₃ inputted thereto, respectively, and two-way mixer portions 55a, 55b and 55c which manage the LAN signals S_{b} and Sₕ, S_{b} and S_{d}, and S_{b} and S_{g}, and the television signals S₃ inputted thereto and outputted therefrom, respectively, so that they do not flow in reverse directions, respectively.

The power source 18 supplies the electric power to each of the two-way distributing portion 52, the 470 MHz LPF portions 53a to 53c, the 470 MHz HPF portions 54a to 54c, and the two-way mixer portions 55a to 55c, and supplies the electric power from the two-way mixer portions 55a to 55c to the signal separating apparatuses 14 and 16, and the signal branching apparatuses 15 and 17 as well through the respective coaxial cables (house wirings) 6a. In addition, since the power source 18 can use a low noise block (LNB) for a 1-st converter for the satellite antenna 3, the LNB which is supplied from at least one of the televisions 8 to 10, and the like installed in a plurality of first to third rooms, respectively, can be used instead of the power source 18 through at least one of the common antenna terminals 7a to 7c, and at least corresponding one of the house wirings 6a.

[Constitution of Signal Separating Apparatus]

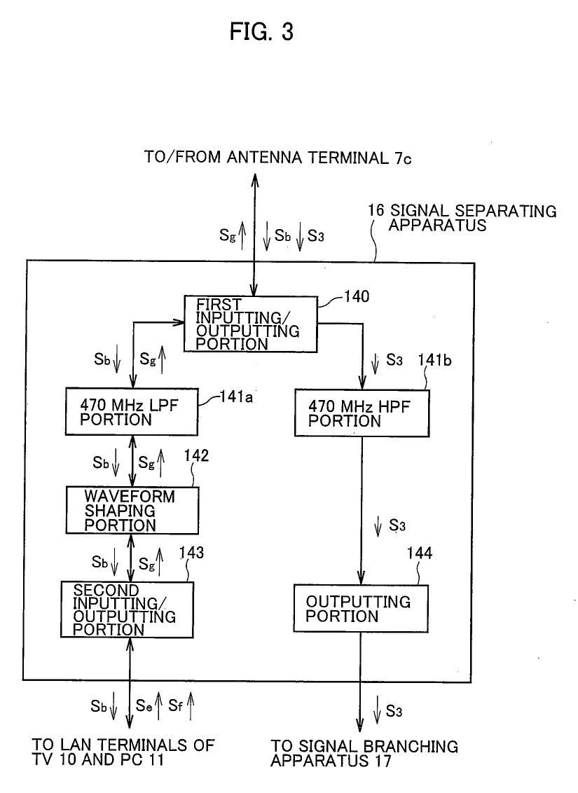

FIG. 3 is an exemplary block diagram of the signal separating apparatus according to the embodiment of the invention. Also, FIG. 3 shows flows of the various kinds of signals associated with the signal separating apparatus installed in the third room shown in FIG. 1. Here, the signal separating apparatus 14 installed in the first room also has the same constitution and function as those of the signal separating apparatus 16 installed in the third room.

The signal separating apparatus 16 is connected to the antenna terminal 7c through an antenna cable. Also, the signal separating apparatus 16 includes a first inputting/outputting portion 140 to and from which the LAN signals S_{b} and S_{g}, and the television signal S₃ obtained through the distribution in the distributor 5 with a hub function are inputted and outputted, a 470 MHz LPF portion 141a which passes therethrough signal components having frequency bands each being lower than 470 MHz of the LAN signals S_{b} and S_{g} inputted thereto, a 470 MHz HPF portion 141b which passes therethrough a signal component having frequency bands each being 470 MHz or more of the television signal S₃ inputted thereto, a waveform shaping portion 142, serving as a second outputting portion, which shapes waveforms of the LAN signal S_{b} and S_{g} which are passed through the 470 MHz LPF portion 141a and a second inputting/outputting portion 143, respectively, the second inputting/outputting portion 143 which is connected to each of the LAN terminals of the television 10 and PC 11, and to and from which the LAN signal S_{b} is inputted and outputted, and the LAN signals Sₑ and S_{f} (refer to FIG. 4) are inputted, and outputted in the form of the LAN signals S_{g}, and an outputting portion 144 which outputs the television signal S₃ to the signal branching apparatus 17. Note that, when the television 10 has the signal branching apparatus 17 built therein, the signal separating apparatus 16 is connected to the antenna terminal of the television 10.

[Operation of Home Network 1]

An operation of the home network according to the embodiment of the invention will be described in detail hereinafter with reference to FIGS. 1 to 5.

FIG. 4 is an exemplary schematic diagram showing flows of the signals in the home network according to the embodiment of the invention.

[Flows of Television Signals]

A ground digital broadcasting wave received at the ground digital wave-receiving antenna 2 is inputted in the form of a television signal S₁ to the booster 4 through corresponding one of booster side connection terminals 40. In addition, a satellite broadcasting wave received at the satellite antenna 3 is inputted in the form of a television signal S₂ to the booster 4 through corresponding one of the booster side connection terminals 40.

The television signals S₁ and S₂ inputted to the booster 4 through the corresponding ones of the booster side connection terminals 40 are amplified by the booster 4, and the resulting multiplexed television signal is inputted in the form of the television signal S₃ to the distributor 5 with a hub function through corresponding one of the booster side connection terminals 40 and the corresponding one of distributor side connection terminals 50.

The television signal S₃ inputted to the distributor 5 with a hub function, as shown in FIG. 2, is distributed in the form of the three television signals S₃ by the RF distributing portion 51 to the 470 MHz HPF portions 54a to 54c.

After the three television signals S₃ are filtered by the 470 MHz HPF portions 54a to 54c, respectively, the resulting television signals S₃ are inputted to the two-way mixer portions 55a to 55c, respectively, and are outputted through the corresponding ones of the distributor side connection terminals 50, respectively.

After being outputted through the corresponding ones of the distributor side connection terminals 50, respectively, the television signals S₃ are propagated through corresponding ones of the coaxial cables 6a serving as the house wirings wired for the televisions 8, 9 and 10 in the first, second and third rooms, respectively, and are then inputted to the signal separating apparatus 14, the television 9 having the signal separating apparatus and the signal branching apparatus built therein, and the signal separating apparatus 16, respectively. Note that, the signal separating apparatus 14, the television 9, and the signal separating apparatus 16 are connected to the antenna terminals 7a, 7b and 7c which are installed in the first, second and third rooms, respectively.

Here, the existing coaxial cables which are wired for the television viewing may be used as the coaxial cables 6a which are wired for the television viewing in the first to third rooms, respectively. In addition, the existing terminals each of which can be connected to the general antenna terminal for the television may be used as the antenna terminals 7a to 7c, respectively. Therefore, the special connectors and the like must not be required.

Taking the signal separating apparatus 16 shown in FIG. 3 as an example, the corresponding one of the two television signals S₃ inputted to the signal separating apparatuses 14 and 16, respectively, is then inputted to the first inputting/outputting portion 140 and is passed through the 470 MHz HPF portion 141b because it cannot be passed through the 470 MHz LPF portion 141a, and the resulting television signals S₃ is then outputted from the outputting portion 144 to the signal branching apparatus 17.

The television signal S₃ inputted to the signal branching apparatus 17 is branched into television signals S₁ and S₂ by the signal branching apparatus 17 in accordance with a difference in frequency band, both the television signals S₁ and S₂ are inputted to the antenna terminal of the television 10, and are then processed inside the television 10. Also, an image corresponding to the video signal obtained in accordance with program selection of both the resulting video signals is displayed in the form of a television program on a display screen of the television 10.

[Flows of LAN Signals]

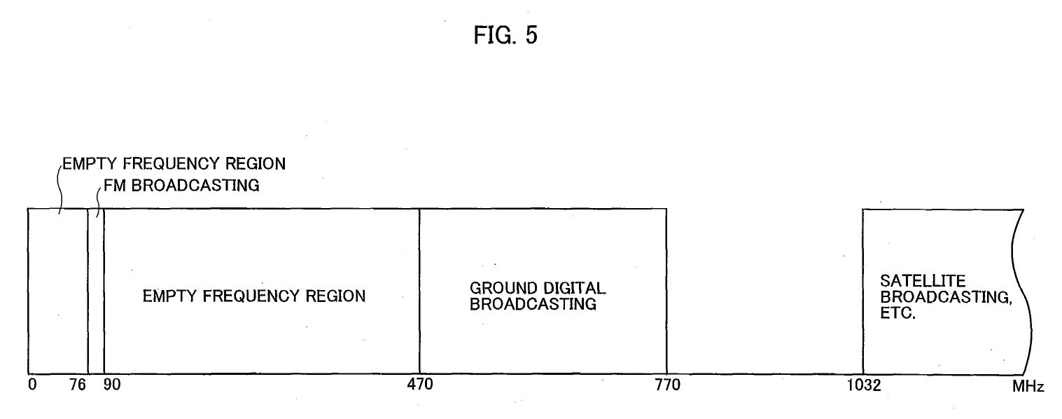

FIG. 5 is an exemplary schematic diagram showing a frequency band in the embodiment of the invention. In the figure, an axis of abscissa represents a frequency (MHz).

As an example, a signal Sₐ transmitted from an Internet provider is propagated through the outside wiring 6b and is inputted to the terminal apparatus 12.

When the terminal apparatus 12 converts the signal Sₐ into the digital signal for a LAN communication, the signal Sₐ is converted into the LAN signal S_{b} having a frequency band lower than 470 MHz.

This conversion process means that since when the ground digital broadcasting is started, the very high frequency (VHF) band (the frequency band lower than 470 MHz) which is formerly used becomes an empty frequency region, this empty frequency region is utilized for the LAN signal S_{b}.

As an example, when no FM broadcasting wave is received, a frequency band from a zero Hz to a frequency lower than 470 MHz can be utilized as the empty frequency region. Therefore, when a band from zero Hz to 200 MHz is used for an up-signal (for the Internet provider), and a band from 230 MHz to 430 MHz is used for a down-signal (for the terminal able to be connected to the Internet), a transmission speed of 100 mega bit per second (Mbps) or more can be obtained in the case of no encoding, and a high transmission speed of 10 giga bps (Gbps) or more can be obtained in the case of the encoding using quadrature phase shift keying (QPSK).

This transmission speed, as an example, is higher than that (an up-transmission speed is 30 Mbps, and a down-transmission speed is 42 Mbps) of a LAN system in a cable television (CATV) using data over cable service interface specifications (DOCSIS) 2.0. The reason for this is because only a band of about 6.4 MHz can be ensured as the band used by the CATV for the up-signal, and only a band of about 6 MHz can be ensured as that band for the down-signal.

The signal Sₐ, as described above, is converted into the LAN signal S_{b} by the terminal apparatus 12, and the resulting LAN signal S_{b} is inputted to the router 13. Then, the router 13 distributes the LAN signal S_{b} to the LAN terminals of the signal separating apparatus 14 and the television 8.

Here, although the LAN signal S_{b} is inputted to the signal separating apparatus 14, it may be directly inputted to the distributor 5 with a hub function. Thus, the input of the LAN signal S_{b} is not limited thereto.

As an example, after the LAN signal S_{b} inputted to the LAN terminal of the television 8 is processed inside the television 8, an image corresponding to the resulting LAN signal S_{b} is displayed together with a program on a display screen of the television 8. For example, the LAN signal S_{b} processed inside the television 8 is displayed in the form of an icon with which a user can select “A” or “B” in a user participation type program on the display screen of the television 8. When the user selects “A” by manipulating a remote controller or the like, a selection signal corresponding to this selection is processed inside the television 8, is inputted in the form of an LAN signal S_{c} to the router 13, and is converted into a signal Sᵢ in the terminal apparatus 12. Then, the resulting signal Sᵢ is transmitted from the Internet provider to a broadcasting station which broadcasts this program through the outside wiring 6b, and is processed therein in correspondence to the selection of “A”.

In addition, the LAN signal S_{b} inputted to the signal separating apparatus is propagated through the corresponding one of the coaxial cables 6a from the antenna terminal 7a in the first room and is inputted to the distributor 5 with a hub function through the corresponding one of the distributor side connection terminals 50.

The LAN signal S_{b} inputted to the distributor 5 with a hub function through the corresponding one of the distributor side connection terminals 50 is inputted to the two-way mixer portion 55a shown in FIG. 2, and a signal component thereof having a necessary frequency band is extracted in the 470 MHz LPF portion 53a. After that, after the resulting signal component is distributed to the 470 MHz LPF portions 53b and 53c by the two-way distributing portion 52, and the noises or the like are removed from the distributed signal components in the 470 MHz LPF portions 53b and 53c, respectively, the resulting LAN signals S_{b} are outputted from the two-way mixer portions 55b and 55c through the corresponding ones of the distributor side connection terminals 50, respectively.

One of the LAN signals S_{b} obtained through the distribution in the distributor 5 with a hub function is propagated through the corresponding one of the coaxial cables 6a wired in the house, and is inputted to the antenna terminal of the television 9 through the antenna terminal 7b in the second room.

Since the television 9 has both the signal separating apparatus and the signal branching apparatus built therein, the viewing of the television program, and the Internet can be utilized by merely connecting the antenna terminal of the television 9 to the antenna terminal 7b of the second room.

When the user manipulates the television 9, the LAN signal S_{d} generated inside the television 9 is propagated through the corresponding one of the coaxial cables 6a from the antenna terminal 7b of the second room, and is inputted to the distributor 5 with a hub function through the corresponding one of the distributor side connection terminals 50. Then, the LAN signal S_{d} is inputted in the form of the LAN signal Sₕ from the distributor 5 with a hub function to the signal separating apparatus 14 of the first room through the corresponding one of the distributor side connection terminals 50, and the corresponding one of the antenna terminals 7a, and is then inputted from the signal separating apparatus 14 to the router 13.

Likewise, the other of the LAN signals S_{b} obtained through the distribution in the distributor 5 with a hub function is propagated through the corresponding one of the coaxial cables 6a wired in the house, and is inputted to the signal separating apparatus 16 through the antenna terminal 7c of the third room.

The LAN signal S_{b} inputted to the signal separating apparatus 16, as shown in FIG. 3, is inputted to the first inputting/outputting portion 140, and the noise or the like is removed from the LAN signal S_{b} in the 470 MHz LPF 141a. After that, the resulting LAN signal S_{b} is shaped in its waveform by the waveform shaping portion 142, and is then outputted from the second inputting/outputting portion 143 to each of the LAN terminals of the television 10 and the PC 11 in the third room.

The LAN signal S_{b} inputted to each of the LAN terminals of the television 10 and the PC 11 in the third room is processed inside each of the television 10 and the PC 11. After that, as an example, in the case of the television 10, an image corresponding to the resulting LAN signal S_{b} is displayed together with a program on a display screen of the television 10. A selection signal which the user selects by manipulating a remote controller or the like is processed inside the television 10, is outputted in the form of a LAN signal Sₑ, and is inputted to the signal separating apparatus 16.

On the other hand, the LAN signal S_{b} which is inputted to the PC 11 and is processed inside the PC 11, as an example, is displayed in the form of an Internet access picture on the display screen of the PC 11. When the user selects a link icon displayed on the Internet access picture, a LAN signal S_{f} is outputted in the form of a selection signal, and is inputted to the signal separating apparatus 16.

Each of the LAN signals Sₑ and S_{f} thus outputted is inputted to the second inputting/outputting portion 143 of the signal separating apparatus 16, is outputted in the form of the LAN signal S_{g}, and is shaped in its waveform in the waveform shaping portion 142. After that, the noise or the like is removed from the LAN signal S_{g} in the 470 MHz LPF portion 141a, and the resulting LAN signal S_{g} is outputted from the first inputting/outputting portion 140.

The LAN signal S_{g} outputted from the first inputting/outputting portion 140 passes through the antenna terminal 7c of the third room, is propagated through the corresponding one of the coaxial cables 6a, and is inputted to the distributor 5 with a hub function through the corresponding one of the distributor side connection terminals 50.

The LAN signal S_{g} inputted to the distributor 5 with a hub function through the corresponding one of the distributor side connection terminals 50 is then inputted to the 470 MHz LPF portion 53c through the two-way mixer portion 55c, and the noise or the like is removed from the LAN signal S_{g} in the 470 MHz LPF portion 53c. After that, the resulting LAN signal S_{g} is inputted to the two-way distributing portion 52, and is then inputted to the two-way mixer portion 55a through the 470 MHz LPF portion 53a.

Here, the two-way mixer portion 55c has such a functional structure as to prevent the LAN signal S_{g} from leaking to the 470 MHz HPF portion 54c to leak from the ground digital wave-receiving antenna 2 and the satellite antenna 3 to the outside through the RF distributing portion 51 of the distributor 5 with a hub function, and the booster 4.

The LAN signal Sₕ inputted to the two-way mixer portion 55a is outputted from the distributor 5 with a hub function through the corresponding one of the distributor side connection terminals 50, is propagated through the corresponding one of the coaxial cables 6a, is inputted to the signal separating apparatus 14 through the antenna terminal 7a of the first room, and is inputted to the terminal apparatus 12 through the router 13. Then, the LAN signal Sₕ is converted into a signal Sᵢ by the terminal apparatus 12, is propagated through the outside wiring 6b, and is transmitted to the Internet provider.

According to the above-mentioned embodiment of the invention, it is possible to separate the television signal and the LAN signal which are propagated through the corresponding one of the house wirings from each other, and it is possible to construct the indoor LAN system utilizing the house wirings. In addition, it is possible to construct the high-quality indoor LAN system having a high transmission speed.

It should be noted that the invention is not intended to be limited to the above-mentioned embodiment, and the various kinds of changes thereof can be made by those skilled in the art without departing from or changing the technical idea of the invention.

What is claimed is:

1. A television•LAN signal-separating apparatus, comprising:
an inputting portion for receiving as its inputs a television signal having a frequency band contained in a first frequency band, and a local area network (LAN) signal having a frequency band contained in a second frequency band through corresponding one of a plurality of common antenna terminals provided in a plurality of rooms, respectively;
a signal separating portion for separating the television signal and the LAN signal from each other in accordance with the first and second frequency bands;
a first outputting portion for outputting the television signal to a television receiver; and
a second outputting portion for outputting the LAN signal to an electronic apparatus.

2. A television•LAN signal-separating apparatus according to claim 1, wherein the first frequency band is equal to or higher than 470 MHz, and the second frequency band is unused one lower than 470 MHz.

3. A television•LAN signal-separating apparatus according to, claim 2, wherein the second frequency band has a band suitable for increasing a signal transmission speed of the LAN signal.

4. A television•LAN signal-separating apparatus according to claim 1, wherein the first outputting portion includes a signal branching portion for branching the television signal into a ground digital television signal and a satellite television signal.

5. A television•LAN signal-separating apparatus according to claim 1, wherein the second outputting portion includes a waveform shaping portion for shaping a waveform of the LAN signal.

6. A television•LAN signal-separating apparatus according to claim 1, wherein the television•LAN signal-separating apparatus is installed inside a television receiver or an electronic apparatus.

7. An indoor LAN system, comprising:
a distributor for distributing or delivering a television signal having a frequency band contained in a first frequency band, and a LAN signal having a frequency band contained in a second frequency band to a plurality of common antenna terminals provided in a plurality of rooms through a house wirings, respectively;
a television•LAN signal-separating apparatus for receiving as its inputs the television signal and the LAN signal through corresponding one of the plurality of common antenna terminals provided in the plurality of rooms, respectively, and outputting the television signal and the LAN signal to a television signal-outputting portion and a LAN signal-outputting portion, respectively, through signal separation; and
a display device for processing at least one of the television signal and the LAN signal separated from each other in the television•LAN signal-separating apparatus.

8. An indoor LAN system according to claim 7, wherein the first frequency band is equal to or higher than 470 MHz, and the second frequency band is unused one lower than 470 MHz.

9. An indoor LAN system according to claim 7, wherein the second frequency band has a band suitable for increasing a signal transmission speed of the LAN signal.

10. An indoor LAN system according to claim 7, wherein the first outputting portion includes a signal branching portion for branching the television signal into a ground digital television signal and a satellite television signal.

11. An indoor LAN system according to claim 7, wherein the second outputting portion includes a waveform shaping portion for shaping a waveform of the LAN signal.

12. An indoor LAN system according to claim 7, wherein the television•LAN signal-separating apparatus is installed in the display device.

13. An indoor LAN system according to claim 7, wherein the distributor uses an active mixer in order to prevent the television signal having the frequency band contained in the first frequency band, and the LAN signal having the frequency band contained in the second frequency band from being transmitted in directions opposite to each other.

14. A television•LAN signal-separating method, comprising the steps of:
receiving as inputs a television signal having a frequency band contained in a first frequency band, and a LAN signal having a frequency band contained in a second frequency band through corresponding one of a plurality of common antenna terminals provided in a plurality of rooms, respectively;
separating the television signal and the LAN signal from each other in accordance with the first and second frequency bands;
outputting the television signal to a television receiver; and
outputting the LAN signal to an electronic apparatus.

15. A television•LAN signal-separating method according to claim 14, wherein the first frequency band is equal to or higher than 470 MHz, and the second frequency band is unused one lower than 470 MHz.

16. A television•LAN signal-separating method according to claim 14, wherein the second frequency band has a band suitable for increasing a signal transmission speed of the LAN signal.

17. A television•LAN signal-separating method according to claim 14, wherein the step of outputting the television signal comprises the step of branching the television signal into a ground digital television signal and a satellite television signal.

18. A television•LAN signal-separating method according to claim 14, wherein the step of outputting the LAN signal comprises the step of shaping a waveform of the LAN signal.
